(19) United States
(12) Patent Application Publication
(10) Pub. No.: US 2015/0271072 A1
(43) Pub. Date: Sep. 24, 2015

(54) METHOD AND APPARATUS FOR RATE CONTROLLED CONTENT STREAMING FROM CACHE

(71) Applicant: CISCO TECHNOLOGY, INC., San Jose, CA (US)

(72) Inventors: Charles Moreman, Grayson, GA (US); Bill Carroll VerSteeg, Buford, GA (US); David R. Oran, Cambridge, MA (US); Ashok Narayanan, Lexington, MA (US)

(73) Assignee: CISCO TECHNOLOGY, INC., San Jose, CA (US)

(21) Appl. No.: 14/223,272

(22) Filed: Mar. 24, 2014

(51) Int. Cl. H04L 12/801; H04L 12/825; H04L 12/835; H04L 29/08; H04L 12/26

(52) U.S. Cl. CPC H04L 47/12; H04L 67/2842; H04L 43/0876; H04L 47/30; H04L 47/25

(57) ABSTRACT

In one embodiment, a method includes measuring at a cache node located on a data path between a content source and an adaptive streaming client, a time to retrieve content from the content source, and rate limiting streaming of the content from the cache node to the adaptive streaming client based on the measured time to retrieve the content. An apparatus and logic are also disclosed herein.

### TECHNICAL FIELD

The present disclosure relates generally to communication networks, and more particularly, to streaming content from cache.

### BACKGROUND

Network caching is used to keep frequently accessed information in a location close to a requester of the information. Web caches are widely used to reduce network congestion and improve overall performance.

### BRIEF DESCRIPTION OF THE FIGURES

FIG. 1 illustrates an example of a network in which embodiments described herein may be implemented.

FIG. 2 depicts an example of a network device useful in implementing embodiments described herein.

FIG. 3 is a flowchart illustrating an overview of a process for streaming content from cache, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises measuring at a cache node located on a data path between a content source and an adaptive streaming client, a time to retrieve content from the content source, and rate limiting streaming of the content from the cache node to the adaptive streaming client based on the measured time to retrieve the content.

In another embodiment, an apparatus generally comprises a processor for measuring at a cache node configured for operation in a data path between a content source and an adaptive streaming client, a time to retrieve content from the content source, and rate limiting streaming of the content to the adaptive streaming client based on the measured time to retrieve the content. The apparatus further comprises memory for storing the time to retrieve the content.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

In adaptive streaming, also referred to as adaptive bitrate (ABR) streaming, dynamic streaming, or live streaming, a source video is encoded such that the same content is available for streaming at a number of different rates. The content stream is generally structured as an array of content chunks (e.g., pieces of content, fragments, segments, or other suitable sub-divisions of an entire instance of content). An adaptive streaming client (e.g., ABR video client) can access chunks stored on servers using a Web paradigm (e.g., HTTP (Hypertext Transfer Protocol) operating over a TCP (Transmission Control Protocol)/IP (Internet Protocol) transport) and make a decision about which specific representation (e.g., video encoding rate) of any given content it will request from the server. The decision may be based on various parameters or observations, including, for example, current bandwidth (e.g., based on monitored delivery rate). Throughout the duration of a given viewing experience, the ABR video client may upshift to a higher encoding rate to obtain better quality when available bandwidth increases, or downshift to a lower encoding rate when available bandwidth decreases.

Adaptive streaming clients may rely on various parameters to make a rate adaptation decision to upshift, downshift, or remain at the current bitrate. Conventional Web caches may cause problems with client rate adaptation algorithms when a cache-hit introduces different network performance than a cache-miss. Problems may include, for example, rate shift oscillation and incorrect steady-state rate adaptation to a level that cannot be supported when the client requests content that is not cached.

The embodiments described herein optimize cache nodes for adaptive streaming content (e.g., ABR video) such that client endpoints see approximately the same network performance of the locally cached rate on a cache-hit as on a cache-miss. The cache node, therefore, does not cause the client to incorrectly rate adapt to an unsustainable bit rate because of differences in performance due to the cache state. The client can upshift to the highest sustainable rate under constant network performance, without upshifting to an unsustainable rate. In one embodiment, performance characteristics such as network delay or maximum bit rate are measured on cache ingest or maximum bit rate is determined as an upper bound for the highest rate locally cached asset. This information is stored and associated with a specific video asset (content) or content source (e.g., CDN (Content Delivery Network) server) or upstream cache. The network information is used on cache egress to pace the streaming content so that the adaptive streaming client obtains the same network throughput on cache-hit as it does on cache-miss. The embodiments may be used to improve client rate adaptation when used with network based caches or in-home gateway based caches, for example.

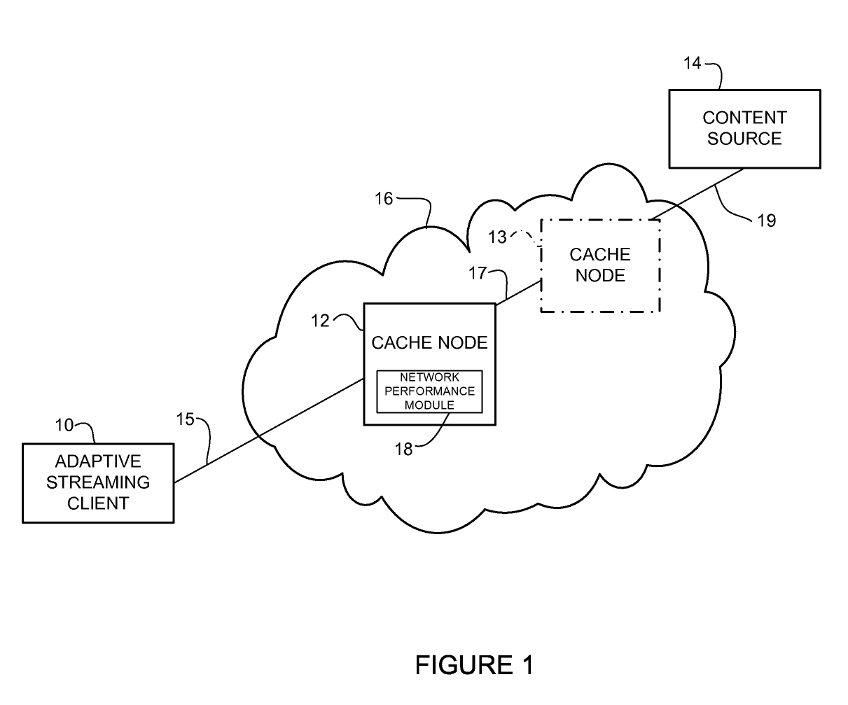

Referring now to the drawings, and first to FIG. 1, an example of a network in which embodiments described herein may be implemented is shown. For simplification, only a small number of nodes in a communication system are shown. The network comprises one or more cache nodes 12, 13 located on a data path between an adaptive streaming client (e.g., endpoint, request originator, content receiver, ABR video client) 10 and a content source (e.g., server, endpoint, CDN node) 14. In the example shown in FIG. 1, cache node 12 includes cache storage for storing received content (data) and a network performance module (e.g., code, logic, or other mechanism) 18 operable to measure and store network performance characteristics between the cache node and content source (e.g., upstream cache node 13, source 14).

In one embodiment, the communication system includes an adaptive streaming video system that makes use of multi-rate video encoding and an IP transport protocol suite (e.g., HTTP/TCP/IP or other equivalent protocols) to deliver high quality streaming video to a plurality of simultaneous users under varying network conditions.

In the example shown in FIG. 1, the adaptive streaming client 10 is in communication with the content source 14 via cache node 12 (or cache nodes 12 and 13) in network 16. The network 16 may include one or more networks (e.g., local area network, metropolitan area network, wide area network, enterprise network, Internet, intranet, radio access network, public switched network, or any other network or combination thereof). Data path 15, 17, 19 between the adaptive streaming client 10 and the source 14 may include any number or type of intermediate nodes (e.g., routers, switches, gateways, or other network devices), which facilitate passage of data between the endpoints (client, source). For example, there may be any number of non-cache intermediate nodes on paths 15, 17, and 19. Also, there may be any number of cache nodes or endpoints. Each cache node may be located, for example, within any number of communication paths between any number of endpoints. Thus, cache node 12 may be used to store data received from any number of sources 14 or requested by any number of clients 10.

The endpoints 10, 14 may operate as source nodes or receiver (destination) nodes and are configured to originate or terminate communications over the network 16. The endpoints may comprise any network device or combination of devices configured for receiving, transmitting, or receiving and transmitting data (content).

The content source 14 is configured with the set of content it is capable of serving up to one or more content receivers 10. The content may include any suitable information that can propagate in the network 16. For example, content may include video, images, graphics, text, Web pages, audio, or other data or combination thereof. The content transmitted from the content source 14 may be encrypted, compressed, or encoded according to any format. There may be any number of content sources 14 providing content to any number of clients 10.

The content source 14 may be, for example, a server (e.g., origin server) or group of servers that store data locally or obtain the content from another server or media source via another network, satellite, cable, or any other communication device or system. The content source 10 may be located in a CDN operable to acquire and stream media. The content delivery network may include streaming applications for content delivery to digital televisions and set-top boxes, and Internet streaming applications for content delivery to IP devices such as personal computers, mobile phones, and handheld devices, for example.

The client 10 may be any network device operable to request and receive content from content source 14. The client 10 may be associated with devices, customers, or end users that want to receive content in the communication system. The client 10 may be wired or wireless and may include, for example, a desktop computer, laptop computer, cellular phone, smart phone, personal digital assistant (PDA), tablet, multimedia device, set-top terminal (box), television with communication capabilities, or any other device operable to initiate and/or respond to video, audio, media, or data exchanges within the communication system. The client 10 may also be a device that seeks to engage in communications on behalf of another entity or element, such as a program, database, or other component.

The cache node 12 may store or cache content that was encoded and segmented at another device (e.g., content source 14). The cache node 12 may comprise, for example, a router, switch, gateway, proxy, server, or other network device. A cache node (e.g., cache node 13) that has stored the requested data may be referred to as the content source, while the data is cached at that node. The cache node 12 sends encoded streams in the form of chunks encoded at different bitrates when requested by the client device 10. In one example, the cache node 12 is configured for use in a content delivery system and operable to acquire and stream media.

In one embodiment, the cache node 12 includes network performance module 18 operable to measure and store network performance characteristics between the cache node 12 and the upstream content source (e.g., cache node 13 or content source 14). As described further below, the performance characteristics may comprise the time to retrieve content (e.g., chunk fetch time, maximum bit rate) from the content source (e.g., cache node 13, content source 14). The performance characteristics are associated with a specific video asset (content) requested by the endpoint 10 or a specific content source (e.g., upstream cache node 13, content source 14, or proxy). The network performance characteristics are used to pace the transmission of the streaming video so that the ABR client 10 measures the same network delay or bitrate on a cache-hit as it would measure on a cache-miss, as described in detail below.

The embodiments may also be used in cut-through switching wherein the cache node 12 forwards the data through to the client 10 when fetching the content, rather than first completely fetching and storing the content.

In the example shown in FIG. 1, only one of the cache nodes includes the network performance module 18, however, any number of cache nodes may include the network performance module.

It is to be understood that the network shown in FIG. 1 and described herein is only an example and that the embodiments may be implemented in networks having different network topologies or network devices, or using different network protocols without departing from the scope of the embodiments. For example, the embodiments are described herein in the context of a computer network environment with content embodied as video. It should be understood that other content (e.g., audio, data, graphics, images, etc.) in lieu of or in addition to video is also considered within the scope of the embodiments. Furthermore, certain embodiments of adaptive streaming systems are described herein in the context of adaptive streaming in an environment that uses HTTP/TCP/IP. It is to be understood that other networks distributing multimedia (e.g., video, graphics, audio, or data) may also benefit from certain embodiments of adaptive streaming systems and methods and are contemplated to be within the scope of the embodiments. For example, other application protocols such as HTTPS (Hypertext Transfer Protocol Secure) or SPDY (SPeeDY) may be used instead of HTTP, or other transports such as SCTP (Stream Control Transmission Protocol), DCCP (Datagram Congestion Control Protocol), or MPTCP (Multipath TCP) may be used instead of TCP.

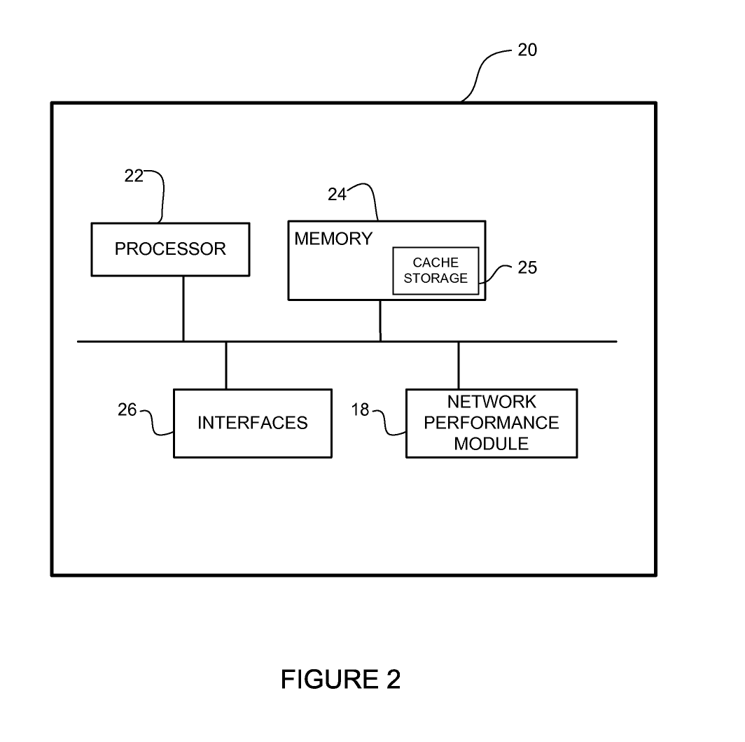

FIG. 2 illustrates an example of a network device 20 (e.g., cache node) that may be used to implement the embodiments described herein. In one embodiment, the network device 20 is a programmable machine that may be implemented in hardware, software, or any combination thereof. The network device 20 includes one or more processor 22, memory 24, network interfaces 26, and network performance module 18.

Memory 24 may be a volatile memory or non-volatile storage, which stores various applications, operating systems, modules, and data for execution and use by the processor 22. Memory 24 includes cache storage 25. Memory 24 may also include network performance module 18 (e.g., logic for determining time to retrieve and table for storing time to retrieve/object (asset/source)).

Logic may be encoded in one or more tangible media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium. In one example, the computer-readable medium comprises a non-transitory computer-readable medium. The network device 20 may include any number of processors 22.

The network interfaces 26 may comprise any number of interfaces (linecards, ports) for receiving data or transmitting data to other devices. The interfaces 26 may include, for example, an Ethernet interface for connection to a computer or network.

It is to be understood that the network device 20 shown in FIG. 2 and described above is only an example and that different configurations of network devices may be used. For example, the network device 20 may further include any suitable combination of hardware, software, algorithms, processors, devices, components, or elements operable to facilitate the capabilities described herein.

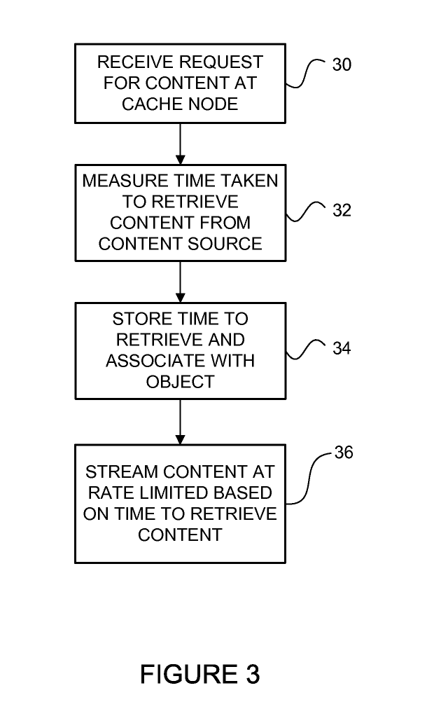

FIG. 3 is a flowchart illustrating a process for streaming content (e.g., video) from cache, in accordance with one embodiment. At step 30, the cache node 12 located on a data path between the content source and the adaptive streaming client 10 receives a request for content. As previously described, the content source may be a server (e.g., CDN node 14), or another cache node (e.g., cache node 13) or proxy that is interposed between the source and the cache node and has cached the content (FIG. 1). If the content is not stored at the cache node 12, the cache node 12 requests the content from the content source. On cache ingest, the cache node 12 measures a time to retrieve the content from the content source (step 32) (FIG. 3). The time to retrieve the content identifies network performance characteristics between the cache node 12 and content source and may comprise, for example, a round trip delay time for the cache node 12 to retrieve the content or a maximum bit rate at which the content is transmitted.

The cache node 12 stores the performance characteristics and associates this information with one or more objects (e.g., video asset (content) or content received from the same source) (step 34). The cache node 12 streams the content to the client 10 at a rate limited based on the time to retrieve the content (step 36). Regardless of whether the cache node 12 has a cache-hit (content already stored at the cache node) or cache-miss (content not stored at cache node), the node streams the content (e.g., HTTP chunks, ABR fragments) with the same delay or bit rate stored at step 34 to approximate the same network performance measured at step 32. The client 10 thus sees approximately the same network performance on a cache-hit as it sees on a cache-miss, which prevents the client from incorrectly rate adapting to an unsustainable bit rate due to the differences in performance based on cache state.

It is to be understood that the process shown in FIG. 3 and described above is only an example and that steps may be added, removed, combined, or modified, without departing from the scope of the embodiments. For example, if the time to retrieve the content has already been stored at the cache node for the same content, similar content, or content with the same source, there is no need to determine the time to retrieve the content. Although, this may be used to refresh the measurement to avoid timing out of the measurement or being exponentially averaged at a different rate. The time to retrieve the content may be determined, for example, upon cache ingest (when objects are added to the cache). Thus, the content may be delivered and stored at the cache node (and retrieval time measured) before a request for content is received from the adaptive streaming client.

Also, it is not a necessary that the object be added to the cache when measuring time to retrieve. The measurement may be stored for later use when fetching a similar chunk of content from the source, or fetching from the same upstream server, for example. This may be used, for example, when a low popularity piece of content (e.g., a targeted advertisement) is fetched (but should not be cached), followed by playout of a popular piece of content that is either not cached or partially cached. The measurement of the fetch time for the advertisement may potentially be used to guide the playout rate of the cached content, since this measurement may be a lot more recent than the measurement obtained from the older fetch of the popular content, and be a better predictor of the performance if there is a cache-miss for the piece of popular content.

In one embodiment, fetch-time measurements (when adding objects to the cache) are processed through a filtering algorithm to produce one or more predicted values for the fetch time a client would experience for un-cached objects. The following describes an example of a filter and estimate process. It is to be understood that this is only an example and other processes may be used.

In one embodiment, the fetched object is mapped into an equivalence class of objects that are expected to exhibit similar fetch time. The equivalence class may be based on any number of criteria. For example, the equivalence class may be based on a matching prefix of the name of the object (e.g., name of entire asset URI (Uniform Resource Identifier) or a content prefix for a set of assets). In another example, the equivalence class may be based on a set of objects fetched from the same origin server (e.g., source 14 in FIG. 1) or from the same upstream proxy node or cache node 13. In yet another example, the equivalence class may be based on a normalized fetch time based on the fetch of a catalog object, such as a manifest describing a set of similar objects. It is to be understood that these are only examples and that other criteria may be used to define an equivalence class of objects.

Once these measurements are filtered and a predictive fetch time is computed, the utility of the prediction may decay with time in the absence of being refreshed. Once the prediction decays it may no longer be used to rate limit fetches. The decay in the prediction may also be based on thresholds set by a management control element to invalidate predictions that are known or suspected of being wrong.

In the process shown in FIG. 3 and described above, the network performance characteristics are determined between cache node 12 and the upstream content source 14 (or next upstream cache node 13). The following describes examples of methods that may be used to measure the time taken to retrieve content from the content source. It is to be understood that these are only examples and that other methods may be used to measure the network performance characteristics, without departing from the scope of the embodiments.

In one embodiment, the retrieval time is identified by measuring the time to retrieve HTTP chunks (ABR fragments) on cache ingest at the cache node 12.

In one embodiment, the provisioned maximum downstream bit rate is determined and used as an upper bound.

In one embodiment, if the cache is filled by advanced methods such as multicast IP or QAM (Quadrature Amplitude Modulation), an estimated ‘equivalent’ HTTP round trip delay or maximum bit rate that would be measured if unicast ABR over HTTP had been used may be determined. In this case, actual measurements of round trip and/or delay of other alternative content from the same source may be used for this estimate.

In one embodiment, the maximum bitrate for the content currently cached on the cache node may be determined. If the client is currently fetching a lower bitrate than the maximum rate locally stored, the bitrate associated with the content may be used rather than the bitrate associated with the current rate. This allows the client to detect that an upshift is desirable.

In one embodiment, in addition to providing an ABR fragment to the client or next hop downstream cache, the cache node 12 may also provide detailed information as to what is limiting the cache's response time. This information may include, for example, whether the limitation is due to network capacity upstream from the cache node, limitations with the next hop upstream cache, limitations due to the source streamer, or limitations of the cache's own capacity. This information may be cascaded through multiple cache nodes recursively toward the client.

In one or more embodiments, if the measured arrival is very slow, rather than rate limiting a cached chunk to play out at a rate significantly below the native rate of the chunk, a lower bound is applied. In one example, the lower bound is the maximum of the measured cache arrival rate or the native rate of the chunk.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
measuring at a cache node located on a data path between a content source and an adaptive streaming client, a time to retrieve content from the content source; and
rate limiting streaming of the content from the cache node to the adaptive streaming client based on the measured time to retrieve the content.

2. The method of claim 1 further comprising associating the time to retrieve the content with one or more objects.

3. The method of claim 2 wherein said one or more objects comprise associated content.

4. The method of claim 2 wherein said one or more objects comprise the content and other content retrieved from the content source.

5. The method of claim 1 wherein rate limiting the streaming of the content comprises limiting a bitrate the content is streamed following a cache-hit.

6. The method of claim 1 wherein rate limiting the streaming of the content comprises streaming the content with a delay to approximate the time to retrieve the content.

7. The method of claim 1 wherein the content source comprises another cache node interposed between the cache node and a content delivery network source.

8. The method of claim 1 wherein the time to retrieve the content comprises a measured round trip time to retrieve the content for a cache-miss.

9. The method of claim 1 wherein the time to retrieve the content comprises a maximum bit rate.

10. The method of claim 1 further comprising identifying a provisioned maximum downstream bit rate and setting an upper limit on the rate based on said provisioned maximum downstream bit rate.

11. The method of claim 1 wherein measuring the time to retrieve the content comprises estimating a time to retrieve based on unicast delivery of the content.

12. The method of claim 1 wherein the adaptive streaming client requests the content at a lower bit rate than the limited rate.

13. The method of claim 1 further comprising transmitting information identifying a limiting factor of the cache node's response time to the adaptive streaming client.

14. An apparatus comprising:
a processor for measuring at a cache node configured for operation in a data path between a content source and an adaptive streaming client, a time to retrieve content from the content source, and rate limiting streaming of the content to the adaptive streaming client based on the measured time to retrieve the content; and
memory for storing the time to retrieve the content.

15. The apparatus of claim 14 wherein the processor is further configured to associate the time to retrieve the content with one or more objects.

16. The apparatus of claim 14 wherein rate limiting the streaming of the content comprises limiting a bitrate the content is streamed following a cache-hit.

17. The apparatus of claim 14 wherein rate limiting the streaming of the content comprises streaming the content with a delay to approximate the time to retrieve the content.

18. The apparatus of claim 14 wherein the time to retrieve the content comprises a measured round trip time to retrieve the content for a cache-miss.

19. The apparatus of claim 14 wherein the processor is further operable to transmit information identifying a limiting factor of the cache node's response time to the adaptive streaming client.

20. Logic encoded on one or more non-transitory computer readable media for execution and when executed operable to:
measure at a cache node located on a data path between a content source and an adaptive streaming client, a time to retrieve content from the content source; and
rate limit streaming of the content to the adaptive streaming client based on the measured time to retrieve the content.
